(19) United States
(12) Patent Application Publication
(10) Pub. No.: US 2026/0342239 A1
(43) Pub. Date: Oct. 29, 2026

(54) MEDIUM-VOLTAGE POWER CONVERSION SYSTEM AND DISTRIBUTED MEDIUM-VOLTAGE POWER CONVERSION SYSTEM

(71) Applicant: DELTA ELECTRONICS, INC., Taoyuan City (TW)

(72) Inventor: Sheng-Hua LI, Taoyuan City (TW)

(21) Appl. No.: 19/718,898

(22) Filed: Jun. 24, 2026

Related U.S. Application Data
(63) Continuation of application No. 18/380,976, filed on Oct. 17, 2023, now Pat. No. 12,689,307.
(60) Provisional application No. 63/435,650, filed on Dec. 28, 2022.

(30) Foreign Application Priority Data
Aug. 7, 2023 (CN) 202310985323.X

(51) Int. Cl. H02M 7/06; H02J 4/25; H02M 1/00; H02M 3/335

(52) U.S. Cl. CPC H02M 7/064; H02J 4/25; H02M 1/0083; H02M 1/008; H02M 3/33576

(57) ABSTRACT

A medium-voltage (MV) power conversion system receives a MV AC power source, and converts the MV AC power source into DC power sources to supply power to loads. The MV power conversion system includes a plurality of power modules, and each power module includes a MV AC switch and a MV isolated AC-to-DC converter. The MV isolated AC-to-DC converter is connected in series to the MV AC switch. Input sides of the plurality of MV AC switches are connected to each other, and connected of the MV AC power source so that the plurality of MV isolated AC-to-DC converters individually convert the MV AC power source into the DC power sources.

### CROSS-REFERENCE TO RELATED APPLICATIONS

This patent application is a continuing application of U.S. patent application Ser. No. 18/380,976, filed on Oct. 17, 2023, which claims the benefit of United States Provisional Patent Application No. 63/435,650, filed Dec. 28, 2022, and claims priority to China patent application Ser. No. 202310985323.X filed on Aug. 07, 2023. The entire disclosures of the above applications are all incorporated by reference herein.

### BACKGROUND

### TECHNICAL FIELD

The present disclosure relates to a medium-voltage power conversion system and a distributed medium-voltage power conversion system, and more particularly to a medium-voltage power conversion system and a distributed medium-voltage power conversion system applied to a solid-state transformer (SST) structure.

### DESCRIPTION OF RELATED ART

The statements in this section merely provide background information related to the present disclosure and do not necessarily constitute prior art.

A complete data center system power structure can be divided into three levels: a system-level power, a rack-level power, and a board-level power. Typically, a medium-voltage power from the power grid, including but not limited to 4kV-35kV alternating current (MVAC), is supplied to the data center as the input power source. MVAC is first converted into alternating current (AC) lines, such as 220-volt or 380-volt lines. The voltages of these AC lines will ultimately be distributed to the racks through UPS to enhance the reliability of power supply.

The AC line voltage is converted through an AC-to-DC converter (commonly known as a switching power supply) inside the rack into a 12-volt or 48-volt direct current (DC) voltage, which is then distributed to the circuit boards. The 12-volt or 48-volt DC voltage will ultimately be converted into multiple sets of lower DC voltages, such as 5 volts, 3.3 volts, 2.5 volts, or 1 volt, to supply power to data processing loads such as CPUs, ASICs, or memory units. Unfortunately, the power conversion efficiency for the motherboard remains below 90%. Taking into account the typical efficiency of 96% for UPS and rack power sources, as well as 99% for transformers, the overall efficiency of the system still falls below 80%.

Therefore, how to design a medium-voltage power conversion system and a distributed medium-voltage power conversion system to solve the problems and technical bottlenecks in the existing technology has become a critical topic in this field.

### SUMMARY

An objective of the present disclosure is to provide a medium-voltage power conversion system. The medium-voltage power conversion system receives a medium-voltage AC power source, and converts the medium-voltage AC power source into at least one low-voltage DC power source to supply power to at least one load. The medium-voltage power conversion system includes a plurality of power modules. Each power module includes a medium-voltage AC switch and a medium-voltage isolated AC-to-DC converter. The medium-voltage isolated AC-to-DC converter is connected to the medium-voltage AC switch. Input sides of the plurality of the medium-voltage AC switches are connected to each other, and are connected to the medium-voltage AC power source so that the plurality of medium-voltage isolated AC-to-DC converters individually convert the medium-voltage AC power source into the at least one low-voltage DC power source.

Another objective of the present disclosure is to provide a distributed medium-voltage power conversion system. The distributed medium-voltage power conversion system includes a plurality of medium-voltage power conversion systems. The plurality of medium-voltage power conversion systems respectively receives a medium-voltage AC power source, and convert the medium-voltage AC power source into at least two low-voltage DC power sources to supply power to at least two loads.

Accordingly, the present disclosure has the following features and advantages: 1. the circuit structure of the present disclosure (with parallel connection on the input side) offers increased power supply design flexibility, versatility, and enhanced power supply coordination performance; 2. through the common interconnection buses among multiple medium-voltage power conversion systems, whose outputs are redundant, interactive redundant power supply can not only enhance power reliability but also provide mutual backup; 3. the low-voltage DC power sources converted by the power modules of the medium-voltage power conversion systems through the DC buses are used to charge and store energy in the battery cabinets, thereby achieving the benefits of uninterrupted DC power backup; 4. multiple medium-voltage power conversion systems may be positioned above or alongside the corresponding battery cabinets and server racks in response to spatial requirements or constraints, thereby enhancing flexibility in space allocation, simplifying wiring complexity, and reducing costs.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a medium-voltage power conversion system according to a first embodiment of the present disclosure.

FIG. 2 is a circuit diagram of a medium-voltage isolated AC-to-DC converter of the medium-voltage power conversion system according to the present disclosure.

FIG. 3 is a block circuit diagram of the medium-voltage power conversion system according to a second embodiment of the present disclosure.

FIG. 4 is a block circuit diagram of a power module of the medium-voltage power conversion system according to a first embodiment of the present disclosure.

FIG. 5 is a block circuit diagram of the power module of the medium-voltage power conversion system according to a second embodiment of the present disclosure.

FIG. 6 is a block circuit diagram of a distributed medium-voltage power conversion system according to the present disclosure.

FIG. 7 is a schematic structure diagram of the distributed medium-voltage power conversion system according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

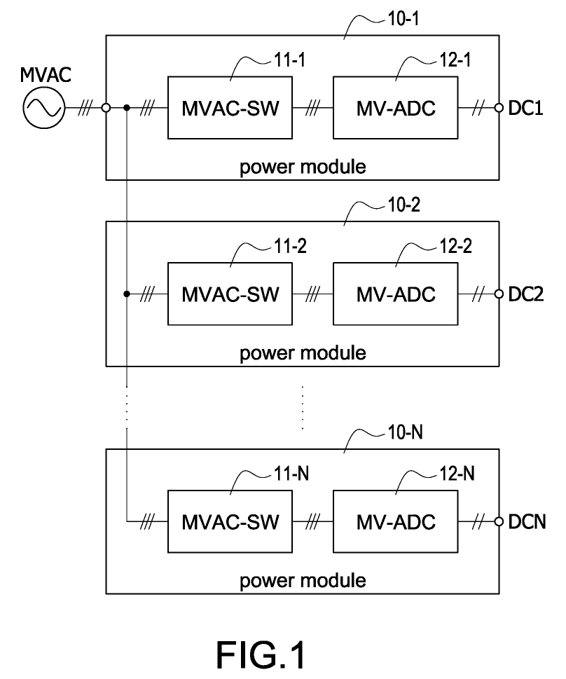

Please refer to FIG. 1, which shows a block circuit diagram of a medium-voltage power conversion system according to a first embodiment of the present disclosure. The medium-voltage power conversion system receives a medium-voltage AC (alternating current) power source MVAC. The voltage of the medium-voltage AC power source MVAC may range from several thousand volts (kV) to tens of thousands of volts, such as but not limited to 4.16 kV, 10 kV, or 13.8 kV. The medium-voltage power conversion system converts the medium-voltage AC power source MVAC into at least one low-voltage DC (direct current) power source DC to supply power to at least one load. The voltage of the at least one low-voltage DC power supply DC may range from tens of volts to hundreds of volts, such as but not limited to 48 volts, 270 volts, or 380 volts. In the present disclosure, the at least one load may be an information technology (IT) load configured in a data center, where information technology covers various technologies for collecting, using, transmitting, and storing digital information, and is a type of information and communication technology. Alternatively, the at least one load may be a charging station. However, the type of load is not intended to limit the technical spirit of the present disclosure.

As shown in FIG. 1, the medium-voltage power conversion system includes a plurality of power modules 10-1 to 10-N, and the circuit structure and electrical behavior of each power module 10-1 to 10-N are the same. In the embodiment shown in FIG. 1, each power module 10-1 to 10-N includes a medium-voltage AC switch (MVAC-SW) 11-1 to 11-N and a medium-voltage isolated AC-to-DC converter (MV-ADC) 12-1 to 12-N. The medium-voltage isolated AC-to-DC converter 12-1 to 12-N is connected to the medium-voltage AC switch 11-1 to 11-N in series. For example, the first power module 10-1 includes a first medium-voltage AC switch 11-1 and a first medium-voltage isolated AC-to-DC converter 12-1 connected in series. The second power module 10-2 includes a second medium-voltage AC switch 11-2 and a second medium-voltage isolated AC-to-DC converter 12-2 connected in series. Similarly, the Nth power module 10-N includes a Nth medium-voltage AC switch 11-N and a Nth medium-voltage isolated AC-to-DC converter 12-N connected in series.

Since each power module 10-1 to 10-N has its own isolation, it is suitable for use with multiple power outputs. In such a circuit structure, the output power of each power module 10-1 to 10-N is relatively low, such as but not limited to 200 kW or lower. Therefore, it is more conducive to the distributed data center structure when applied to the low-power solid-state transformer (SST) platform.

In this embodiment, input sides of these medium-voltage AC switches 11-1 to 11-N are connected to each other and connected to the medium-voltage AC power source MVAC so that each medium-voltage isolated AC-to-DC converter 12-1 to 12-N can individually perform DC conversion on the medium-voltage AC power source MVAC to generate the low-voltage DC power source DC1-DCN. For example, an input side of the first medium-voltage AC switch 11-1, an input side of the second medium-voltage AC switch 11-2, …, and an input side of the Nth medium-voltage AC switch 11-N are connected to each other. Essentially these input sides are connected in parallel and then connected to the medium-voltage AC power source MVAC. Compared with the circuit structure where these input sides are connected in series, based on power balance considerations, each power module must work at the same power to jointly output power through a single output terminal. Therefore, the circuit structure of the present disclosure (theses input sides are connected in parallel) has better power design flexibility and better power cooperative operation performance.

When the first medium-voltage AC switch 11-1 is turned on, the first medium-voltage isolated AC-to-DC converter 12-1 converts the medium-voltage AC power source MVAC to generate a first low-voltage DC power source DC1 by the AC-to-DC conversion. When the second medium-voltage AC switch 11-2 is turned on, the second medium-voltage isolated AC-to-DC converter 12-2 converts the medium-voltage AC power source MVAC to generate a second low-voltage DC power source DC2 by the AC-to-DC conversion. Similarly, when the Nth medium-voltage AC switch 11-N is turned on, the Nth medium-voltage isolated AC-to-DC converter 12-N converts the medium-voltage AC power source MVAC to generate a Nth low-voltage DC power source DCN by the AC-to-DC conversion. However, the above-mentioned AC-to-DC conversion operation does not limit only one power module to operate at the same time, and can control the corresponding medium-voltage AC switches 11-1 to 11-N to be turned on according to the demand of the load. Therefore, the corresponding medium-voltage isolated AC-to-DC converters 12-1 to 12-N can be controlled to perform AC-to-DC conversion to generate corresponding low-voltage DC power sources DC1 to DCN.

In one embodiment, each of the medium-voltage isolated AC-to-DC converters 12-1 to 12-N is a three-phase single-stage AC-to-DC converter. Therefore, the received medium-voltage AC power source MVAC is a three-phase AC power source. Specifically, each phase of the three-phase medium-voltage AC power source MVAC is correspondingly connected to each phase of the corresponding three-phase AC-to-DC converter through three-phase medium-voltage AC switches 11-1 to 11-N.

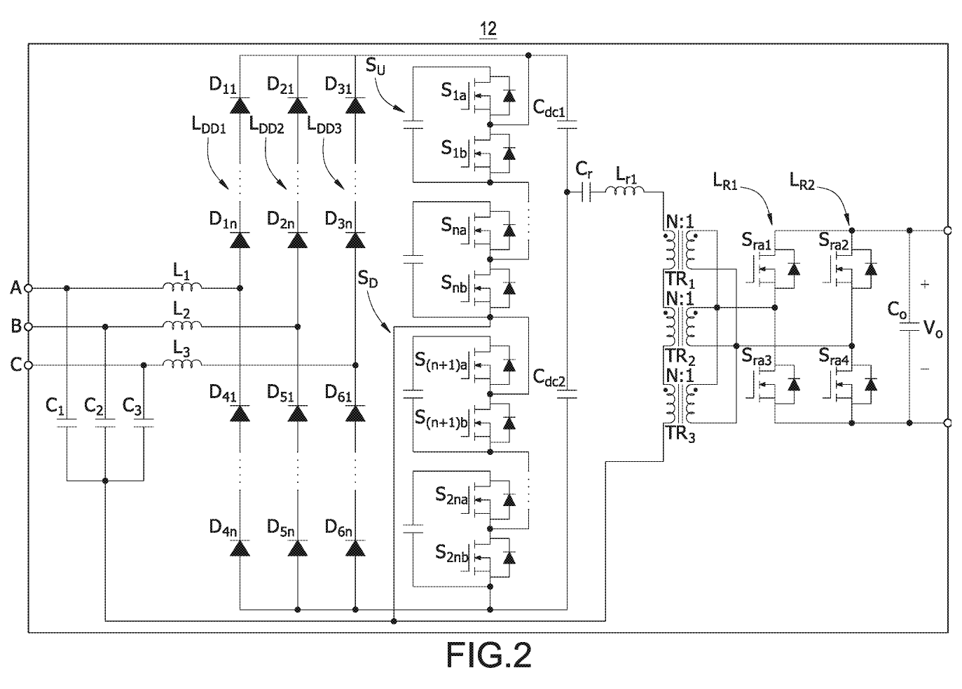

Please refer to FIG. 2, which shows a circuit diagram of a medium-voltage isolated AC-to-DC converter of the medium-voltage power conversion system according to the present disclosure. The medium-voltage isolated AC-to-DC converter 12 shown in FIG. 2 is a three-phase AC-to-DC converter, and its input ends A, B, C are correspondingly connected to three phases R, S, T of the medium-voltage AC power source MVAC. As mentioned above, since the medium-voltage isolated AC-to-DC converters 12-1 to 12-N are connected in parallel, the input voltage of each medium-voltage isolated AC-to-DC converter 12-1 to 12-N is the medium-voltage AC power source MVAC. Therefore, for each medium-voltage isolated AC-to-DC converter 12-1 to 12-N, it is an indispensable consideration to have a withstand voltage circuit design.

Accordingly, the medium-voltage isolated AC-to-DC converter 12 shown in FIG. 2 includes three transformers TR₁, TR₂, TR₃, a primary-side circuit, and a secondary-side circuit. Each transformer TR₁, TR₂, TR₃ includes a primary-side winding and a secondary-side winding. In particular, the three primary-side windings are coupled in series to form a primary side, and the three secondary-side windings are coupled in parallel to form a secondary side.

The primary-side circuit is coupled to the primary side, and the primary-side circuit includes three input capacitors C₁, C₂, C₃, three input inductors L₁, L₂, L₃, three diode bridge arms L_{DD1}, L_{DD2}, L_{DD3}, a switch conversion stage S_{U}, S_{D}, a capacitor assembly C_{dc1}, C_{dc2}, and a resonant circuit Cᵣ, Lᵣ₁. The three input capacitors C₁, C₂, C₃ are respectively connected to three inputs of the medium-voltage AC power source MVAC. The three input inductors L₁, L₂, L₃ are respectively connected to the three inputs of the medium-voltage AC power source MVAC. The three diode bridge arms L_{DD1}, L_{DD2}, L_{DD3} are respectively connected to the three input inductors L₁, L₂, L₃. The switch conversion stage S_{U}, S_{D} is connected to the three diode bridge arms L_{DD1}, L_{DD2}, L_{DD3} in parallel. The capacitor assembly C_{dc1}, C_{dc2} is connected to the switch conversion stage S_{U}, S_{D} in parallel. The resonant circuit Cᵣ, Lᵣ₁ is connected between the capacitor assembly C_{dc1}, C_{dc2} and the primary side.

The secondary-side circuit is coupled to the secondary side, and the secondary-side circuit includes rectification switch bridge arms L_{R1}-L_{R2} and an output capacitor Co, and the output capacitor Co is connected to the rectification switch bridge arms L_{R1}-L_{R2}.

Specifically, as shown in FIG. 2, the three input capacitors C₁, C₂, C₃ are connected to the three inputs of the medium-voltage AC power source MVAC. The three input inductors L₁, L₂, L₃ include a first input inductor L₁, a second input inductor L₂, and a third input inductor L₃. In one embodiment, the first input inductor L₁ is connected to the first input capacitors C₁ and an R phase of the medium-voltage AC power source MVAC, the second input inductor L₂ is connected to the second input capacitors C₂ and an S phase of the medium-voltage AC power source MVAC, and the third input inductor L₃ is connected to the third input capacitors C₃ and a T phase of the medium-voltage AC power source MVAC.

The three diode bridge arms L_{DD1}, L_{DD2}, L_{DD3} include a first diode bridge arm L_{DD1}, a second diode bridge arm L_{DD2}, and a third diode bridge arm L_{DD3}. The first diode bridge arm L_{DD1} includes a first upper bridge arm and a first lower bridge arm. The first upper bridge arm includes a plurality of diodes D₁₁-D₁ₙ connected in series and the first lower bridge arm includes a plurality of diodes D₄₁-D₄ₙ connected in series. The first upper bridge arm and the first lower bridge arm are commonly connected with the first input inductor L₁. The second diode bridge arm L_{DD2} includes a second upper bridge arm and a second lower bridge arm. The second upper bridge arm includes a plurality of diodes D₂₁-D₂ₙ connected in series and the second lower bridge arm includes a plurality of diodes D₅₁-D₅ₙ connected in series. The second upper bridge arm and the second lower bridge arm are commonly connected with the second input inductor L₂. The third diode bridge arm L_{DD3} includes a third upper bridge arm and a third lower bridge arm. The third upper bridge arm includes a plurality of diodes D₃₁-D₃ₙ connected in series and the third lower bridge arm includes a plurality of diodes D₆₁-D₆ₙ connected in series. The third upper bridge arm and the third lower bridge arm are commonly connected with the third input inductor L₃. Therefore, by designing the three diode bridge arms L_{DD1}, L_{DD2}, L_{DD3} to be a structure in which components are connected in series, that is, each upper or lower bridge arm has multiple diodes connected in series to increase the voltage withstand of each diode bridge arm to the medium-voltage AC power source MVAC.

The switch conversion stage S_{U}, S_{D} includes an upper switch bridge arm S_{U} and a lower switch bridge arm S_{D} connected in series. The upper switch bridge arm S_{U} includes a plurality of switch modules connected in series, and each switch module includes two active switches S₁ₐ-S_{1b}, Sₙₐ-S_{nb} connected in series. The lower switch bridge arm S_{D} includes a plurality of switch modules connected in series, and each switch module includes two active switches S₍ₙ₊₁₎ₐ-S_{(n+1)b}, S₂ₙₐ-S_{2nb} connected in series. Therefore, the switch conversion stage S_{U}, S_{D} includes 2n switch modules in total.

A common-connected node of the first switch module S₁ₐ-S_{1b} of the upper switch bridge arm S_{U} is connected to a total cathode end (i.e., a positive end of the system) of the three diode bridge arms L_{DD1}, L_{DD2}, L_{DD3}. A common-connected node of the first switch module S₍ₙ₊₁₎ₐ-S_{(n+1)b} of the lower switch bridge arm S_{D} is connected to the active switch S_{nb} of the last switch module Sₙₐ-S_{nb} of the upper switch bridge arm S_{U}, and connected to a common-connected node of the three input capacitors C₁, C₂, C₃ and the primary side, i.e., a neutral end of an input side of the medium-voltage isolated AC-to-DC converter 12. The active switch S_{2nb} of the last switch module S₂ₙₐ-S_{2nb} of the lower switch bridge arm S_{D} is connected to a total anode end (i.e., a negative end of the system) of the three diode bridge arms L_{DD1}, L_{DD2}, L_{DD3}.

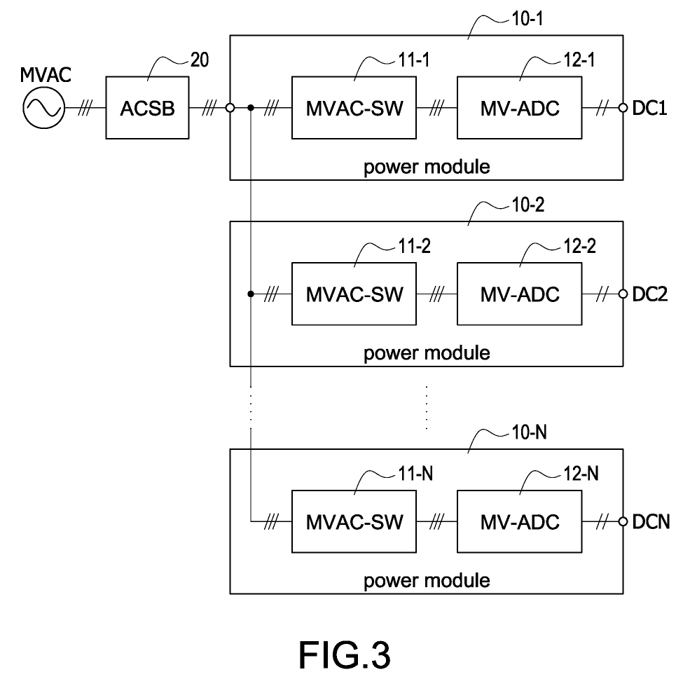

Please refer to FIG. 3, which shows a block circuit diagram of the medium-voltage power conversion system according to a second embodiment of the present disclosure. The major difference between the second embodiment shown in FIG. 3 and the first embodiment shown in FIG. 1 is that the medium-voltage power conversion system further includes an AC switchboard 20. In one embodiment, the AC switchboard 20 is a three-phase AC switchboard is also referred to a distribution panel or a switch box. The AC switchboard 20 is connected between input ends of the plurality of medium-voltage AC switches 11-1 to 11-N and the medium-voltage AC power source MVAC. The AC switchboard 20 is a complete set of devices for centralized installation of switches, meters and other equipment, and used to assemble the switches and circuit breaker equipment, measurement instruments, protective appliances, and auxiliary equipment on the panels of the metal cabinet to easily to manage and facilitates maintenance when circuit failures occur. In other words, the AC switchboard 20 can be easily disconnected and separated from the feeder of the previous medium-voltage AC power source MVAC when the solid-state transformer (SST) system needs to be maintained or repaired.

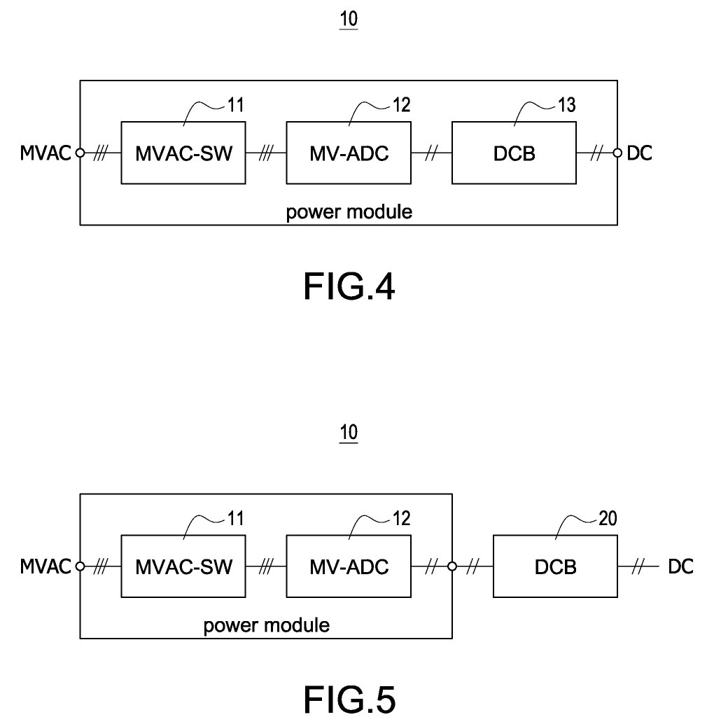

Please refer to FIG. 4, which shows a block circuit diagram of a power module of the medium-voltage power conversion system according to a first embodiment of the present disclosure. The major difference between the power module 10 shown in FIG. 4 and the power module shown in FIG. 1 is that the power module 10 further includes a DC circuit breaker 13, that is, the DC circuit breaker 13 is disposed inside the power module 10 and controlled by a controller inside the power module 10. The DC circuit breaker 13 is connected between the output side of the medium-voltage isolated AC-to-DC converter 12 and the load LD1, LD2. When the power module 10 is abnormal (for example but not limited to, an over-voltage abnormality, an over-current abnormality, or an over-temperature abnormality), the DC circuit breaker 13 controlled to disconnect the load LD1, LD2 from peripheral circuits connected to the load LD1, LD2 so as to avoid affecting the peripheral circuits and further implement the corresponding over-voltage protection, over-current protection, or over-temperature protection. Alternatively, when the load LD1, LD2 is abnormal, the load LD1, LD2 will be isolated/separated from the power module 10 by disconnecting the DC circuit breaker 13 so as to protect the power module 10. Alternatively, the DC circuit breaker 13 can be actively isolated at specific times based on pre-scheduling within the entire medium-voltage power conversion system to disconnect the loads LD1, LD2 from the power module 10.

Please refer to FIG. 5, which shows a block circuit diagram of the power module of the medium-voltage power conversion system according to a second embodiment of the present disclosure. The major difference between the second embodiment shown in FIG. 5 and the first embodiment shown in FIG. 4 is that the DC circuit breaker 13 is disposed outside the power module 10. That is, the DC circuit breaker 20 is connected to the output side of the power module 10, i.e., between the medium-voltage isolated AC-to-DC converter 12-1 to 12-N and the load LD1, LD2. The DC circuit breaker 20 disposed outside the power module 10 can be used to easily disconnect the single power module 10 of the solid-state transformer (SST) system and separate it from the rear-end load without affecting other circuits under the normal operation when the power module 10 needs to be maintained or repaired. In this embodiment, the DC circuit breaker 20 may be a mechanical switch, which can be controlled manually or through a circuit so as to achieve the functions described in the embodiment shown in FIG. 4.

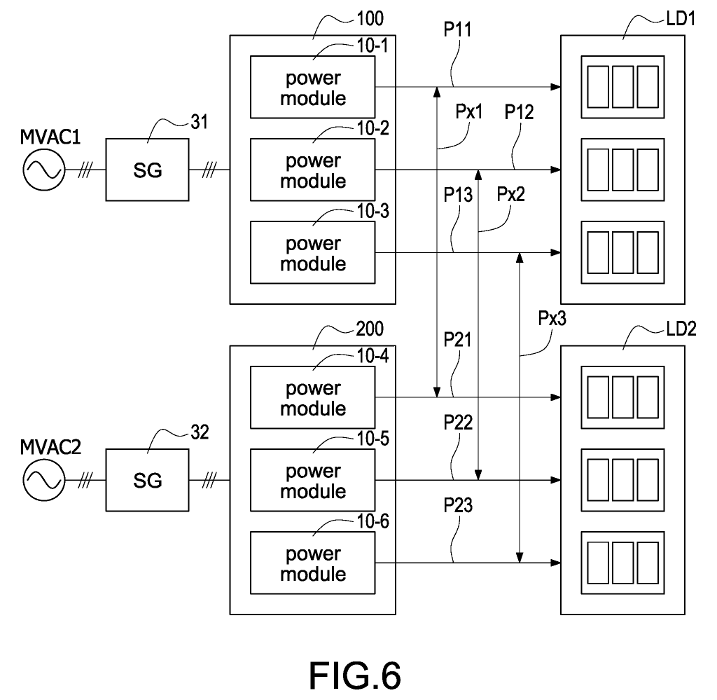

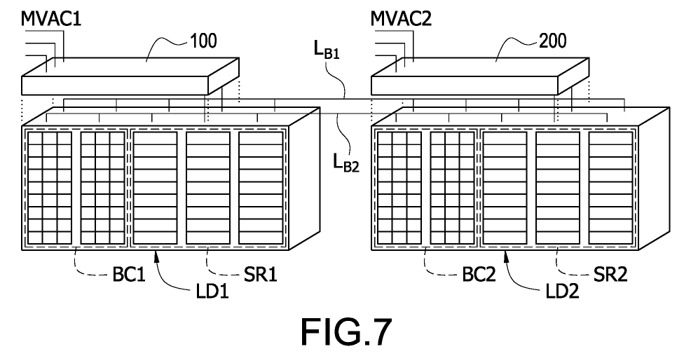

Please refer to FIG. 6 and FIG. 7, which respectively show a block circuit diagram and a schematic structure diagram of a distributed medium-voltage power conversion system according to the present disclosure. As shown in FIG. 6, the distributed medium-voltage power conversion system includes two medium-voltage power conversion systems, but this is not intended to limit the present disclosure, i.e., may include more than two medium-voltage power conversion systems. Taking FIG. 6 and FIG. 7 as an example, the distributed medium-voltage power conversion system includes a first medium-voltage power conversion system 100 and a second medium-voltage power conversion system 200. The first medium-voltage power conversion system 100 receives a first medium-voltage AC power source MVAC1 through a first switchgear 31 of the AC switchboard 20 shown in FIG. 3, and converts the first medium-voltage AC power source MVAC1 into a plurality of low-voltage DC power sources to supply power to a first load LD1 and/or a second load LD2. The second medium-voltage power conversion system 200 receives a second medium-voltage AC power source MVAC2 through a second switchgear 32 of the AC switchboard 20 shown in FIG. 3, and converts the second medium-voltage AC power source MVAC2 into a plurality of low-voltage DC power sources to supply power to the first load LD1 and/or the second load LD2. The detail descriptions are as follows.

In the embodiment shown in FIG. 6, the first medium-voltage power conversion system includes three power modules, having a first power module 10-1, a second power module 10-2, and a third power module 10-3. The second medium-voltage power conversion system includes three power modules, having a fourth power module 10-4, a fifth power module 10-5, and a sixth power module 10-6. The low-voltage DC power sources generated by the first medium-voltage power conversion system and the second medium-voltage power conversion system can separately supply power to the first load LD1 and the second load LD2, or can jointly supply power to the first load LD1 or the second load LD2.

Compared with the existing SST power conversion and power supply operations for downstream equipment, it provides a single integrated structure with megawatt (MW)-level power supply capability. Therefore, a single SST is sufficient to provide the required power to multiple clusters (where each cluster includes multiple racks). For example, the output power of a single SST in the existing structure is about 1-1.2 MW. It is assumed that one cabinet needs 40kW of power electricity, and therefore one SST can supply about 30 cabinets. Since these cabinets are wired together, they are powered by the same SST. However, once the power module in the SST is damaged, the SST will no longer be able to provide such a high-wattage power supply capability, and the cabinets powered by it will be unusable due to power failure, thus greatly reducing the reliability of its power supply.

Compared with the existing SST with megawatt-level output supply capability, in the present disclosure, the output of each SST is about 200kW (smaller volume), which has the advantage of distributed power supply. For example, it is assumed each SST supplies power to a cluster with three cabinets (requiring 120kW). When input DC terminals of two clusters are connected together, each SST can be used by cabinets of different clusters, in other words, one SST can supply power of 240kW required by two clusters having 6 cabinets in short-term overload power electricity.

Specifically, a first low-voltage DC power source generated by the first power module 10-1 supplies power to the first load LD1 through a first power-supplying path P11. A second low-voltage DC power source generated by the second power module 10-2 supplies power to the first load LD1 through a second power-supplying path P12. A third low-voltage DC power source generated by the third power module 10-3 supplies power to the first load LD1 through a third power-supplying path P13. A fourth low-voltage DC power source generated by the fourth power module 10-4 supplies power to the second load LD2 through a fourth power-supplying path P21. A fifth low-voltage DC power source generated by the fifth power module 10-5 supplies power to the second load LD2 through a fifth power-supplying path P22. A sixth low-voltage DC power source generated by the sixth power module 10-6 supplies power to the second load LD2 through a sixth power-supplying path P23.

In particular, a first connection path Px1 is provided between the first power-supplying path P11 and the fourth power-supplying path P21, a second connection path Px2 is provided between the second power-supplying path P12 and the fifth power-supplying path P22, and a third connection path Px3 is provided between the third power-supplying path P13 and the sixth power-supplying path P23.

In another embodiment shown in FIG. 6, the first low-voltage DC power source generated by the first power module 10-1 further supplies power to the second load LD2 through the first connection path Px1 and the fourth power-supplying path P21. The second low-voltage DC power source generated by the second power module 10-2 further supplies power to the second load LD2 through the second connection path Px2 and the fifth power-supplying path P22. The third low-voltage DC power source generated by the third power module 10-3 further supplies power to the second load LD2 through the third connection path Px3 and the sixth power-supplying path P23. The fourth low-voltage DC power source generated by the fourth power module 10-4 further supplies power to the first load LD1 through the first connection path Px1 and the first power-supplying path P11. The fifth low-voltage DC power source generated by the fifth power module 10-5 further supplies power to the first load LD1 through the second connection path Px2 and the second power-supplying path P12. The sixth low-voltage DC power source generated by the sixth power module 10-6 further supplies power to the first load LD1 through the third connection path Px3 and the third power-supplying path P13.

Accordingly, the distributed medium-voltage power conversion system of the present disclosure can provide the function of redundant power supply. When the two medium-voltage power conversion systems are both normal, the low-voltage DC power generated by itself can be provided to supply the required power to the loads which are responsible for. However, once any one of the medium-voltage power conversion systems occurs abnormality, the normal medium-voltage power conversion systems can not only supply power to the loads which are responsible by the normal medium-voltage power conversion systems, but also supply power to the load which is responsible by the abnormal medium-voltage power conversion system, thereby significantly increasing the reliability of the power supply.

For example, when the first medium-voltage AC power source MVAC1 and the second medium-voltage AC power source MVAC2 both normally supply power, the low-voltage DC power sources generated by the first power module 10-1, the second power module 10-2, and the third power module 10-3 can supply power to the first load LD1 through the first power-supplying path P11, the second power-supplying path P12, and the third power-supplying path P13, respectively. Similarly, the low-voltage DC power sources generated by the fourth power module 10-4, the fifth power module 10-5, and the sixth power module 10-6 can supply power to the second load LD2 through the fourth power-supplying path P21, the fifth power-supplying path P22, and the sixth power-supplying path P23, respectively.

Once the second medium-voltage AC power source MVAC2 occurs abnormality, not only the low-voltage DC power sources generated by the first power module 10-1, the second power module 10-2, and the third power module 10-3 can supply power to the first load LD1 through the first power-supplying path P11, the second power-supplying path P12, and the third power-supplying path P13, respectively, but also the low-voltage DC power source generated by the first power module 10-1 can further supply power to the second load LD2 through the first connection path Px1 and the fourth power-supplying path P21, the low-voltage DC power source generated by the second power module 10-2 can further supply power to the second load LD2 through the second connection path Px2 and the fifth power-supplying path P22, and the low-voltage DC power source generated by the third power module 10-3 can further supply power to the second load LD2 through the third connection path Px3 and the sixth power-supplying path P23. Accordingly, normal operation of all loads can be maintained until the second medium-voltage AC power source MVAC2 is restored.

The schematic structure diagram of the above-mentioned two medium-voltage power conversion systems is shown in FIG. 7. In particular, the first load LD1 and the second load LD2 may be information technology (IT) loads disposed in a data center, which respectively have a plurality of battery cabinets BC1, BC2 and a plurality of server racks SR1, SR2. As shown in FIG. 7, due to the miniaturization of a single medium-voltage power conversion system, SST performs a distributed design into a modular structure, that is, a decentralized modular architecture, the first medium-voltage power conversion system 100 and the second medium-voltage power conversion system 200 configured with a plurality of power modules can be respectively installed on the corresponding loads LD1, LD2. That is, shared DC buses LB1, LB2 are used to execute the operation of redundant power supply for the battery cabinets BC1, BC2 and the server racks SR1, SR2 of the loads LD1, LD2. In this way, the low-voltage DC power sources converted by the power modules of the medium-voltage power conversion systems are transmitted to the battery cabinets BC1, BC2 through the DC buses LB1, LB2 to charge and store energy. Compared to traditional uninterrupted AC power backup system that require two-stage power conversions, including AC-to-DC and DC-to-AC conversions, the backup efficiency is better. In addition, the first medium-voltage power conversion system 100 and the second medium voltage conversion system 200 can also be arranged on the sides of the battery cabinets BC1, BC2 and the server racks SR1, SR2 respectively (not shown in figures) in response to the height restriction of the available space, and therefore the redundant power supply operation can also be realized through the shared DC

Incidentally, each group of SST modules only needs to provide stable power to the downstream devices and loads for which it is responsible. The upstream power supply equipment for these SST modules can be centrally controlled to determine the status of each SST module and its corresponding feeder line, as well as to coordinate the operation of power supply to the individual SST module. Moreover, during annual maintenance, routine maintenance, or in the event of power abnormalities of the SST modules, the respective decoupling switches can be used to disconnect each SST module.

### In summary, the present disclosure has the following features and advantages:

1. The circuit structure of the present disclosure (with parallel connection on the input side) offers increased power supply design flexibility, versatility, and enhanced power supply coordination performance.
2. Through the common interconnection buses among multiple medium-voltage power conversion systems, whose outputs are redundant, interactive redundant power supply can not only enhance power reliability but also provide mutual backup.
3. The low-voltage DC power sources converted by the power modules of the medium-voltage power conversion systems through the DC buses are used to charge and store energy in the battery cabinets, thereby achieving the benefits of uninterrupted DC power backup.
4. Multiple medium-voltage power conversion systems may be positioned above or alongside the corresponding battery cabinets and server racks in response to spatial requirements or constraints, thereby enhancing flexibility in space allocation, simplifying wiring complexity, and reducing costs.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method for controlling a medium-voltage power conversion system, the medium-voltage power conversion system including a plurality of power modules, each of the plurality of power modules including a medium-voltage AC switch and a medium-voltage isolated AC-to-DC converter, the method comprising:
determining, based on a load demand associated with at least one load, a subset of the plurality of power modules to be enabled;
controlling the medium-voltage AC switches of the subset of the plurality of power modules to electrically connect the subset of the plurality of power modules to a medium-voltage AC power source;
controlling the medium-voltage isolated AC-to-DC converters of the subset of the plurality of power modules to convert the medium-voltage AC power source into a corresponding low-voltage DC power; and
distributing the corresponding low-voltage DC power from the subset of the plurality of power modules to the at least one load.

2. The method for controlling the medium-voltage power conversion system as claimed in claim 1, further comprising monitoring the load demand associated with the at least one load and dynamically updating the subset of the plurality of power modules according to the monitored load demand.

3. The method for controlling the medium-voltage power conversion system as claimed in claim 1, wherein determining the subset comprises selecting one or more power modules among the plurality of power modules according to an aggregate load demand.

4. The method for controlling the medium-voltage power conversion system as claimed in claim 1, further comprising increasing a number of enabled power modules when an aggregate load demand exceeds a first condition and decreasing the number of enabled power modules when the aggregate load demand falls below a second condition.

5. The method for controlling the medium-voltage power conversion system as claimed in claim 1, further comprising reconfiguring the subset of the plurality of power modules over time in response to variation of the load demand.

6. The method for controlling the medium-voltage power conversion system as claimed in claim 1, wherein distributing the corresponding low-voltage DC power comprises supplying different portions of the corresponding low-voltage DC power from different power modules to respective loads.

7. The method for controlling the medium-voltage power conversion system as claimed in claim 1, wherein distributing the corresponding low-voltage DC power comprises supplying a same load with low-voltage DC power generated by at least two power modules.

8. The method for controlling the medium-voltage power conversion system as claimed in claim 1, wherein the medium-voltage power conversion system is included in a distributed power conversion architecture that includes another medium-voltage power conversion system, and the method further comprises:
controlling a power connection path between the medium-voltage power conversion system and the another medium-voltage power conversion system to enable power transfer therebetween.

9. The method for controlling the medium-voltage power conversion system as claimed in claim 8, further comprising, in response to an abnormal condition of the another medium-voltage power conversion system, supplying power from one of the plurality of power modules to a load associated with the another medium-voltage power conversion system through the power connection path.

10. The method for controlling the medium-voltage power conversion system as claimed in claim 8, further comprising, when both systems are in normal operation, supplying additional power from one of the plurality of power modules to a load associated with the another medium-voltage power conversion system when a power demand of the load exceeds a supply capability of the another medium-voltage power conversion system.

11. The method for controlling the medium-voltage power conversion system as claimed in claim 1, further comprising detecting an abnormal condition associated with at least one of the plurality of power modules or the at least one load and, in response thereto, electrically isolating the at least one of the plurality of power modules or the at least one load from the medium-voltage power conversion system.

12. The method for controlling the medium-voltage power conversion system as claimed in claim 11, wherein electrically isolating comprises controlling at least one of the medium-voltage AC switch or a DC circuit breaker to disconnect an electrical path associated with the at least one of the plurality of power modules or the at least one load from the medium-voltage power conversion system.

13. The method for controlling the medium-voltage power conversion system as claimed in claim 1, further comprising disconnecting at least one power module from the medium-voltage AC power source during maintenance and continuing supplying the at least one load using another power module.

14. The method for controlling the medium-voltage power conversion system as claimed in claim 1, further comprising centrally coordinating operation of the plurality of power modules based on respective operating statuses of the plurality of power modules.

15. The method for controlling the medium-voltage power conversion system as claimed in claim 1, further comprising transmitting at least a portion of the corresponding low-voltage DC power to a shared DC bus for supplying energy to a storage system.

16. A medium-voltage power conversion system, comprising:
a plurality of power modules, each of the plurality of power modules including a medium-voltage AC switch and a medium-voltage isolated AC-to-DC converter; and
a control unit configured to:
determine, based on a load demand associated with at least one load, a subset of the plurality of power modules to be enabled;
control medium-voltage AC switches of the subset of the plurality of power modules to electrically connect the subset of the plurality of power modules to a medium-voltage AC power source;
control the medium-voltage isolated AC-to-DC converters of the subset of the plurality of power modules to convert the medium-voltage AC power source into corresponding low-voltage DC power; and
distribute the corresponding low-voltage DC power to the at least one load.

17. The medium-voltage power conversion system as claimed in claim 16, wherein the control unit is further configured to detect an abnormal condition and isolate at least one of the plurality of power modules or the at least one load.

18. The medium-voltage power conversion system as claimed in claim 16, wherein the control unit is further configured to disconnect at least one power module from the medium-voltage AC power source during maintenance while maintaining power supply to the at least one load.

19. The medium-voltage power conversion system as claimed in claim 16, wherein the control unit is further configured to:
monitor an operating status of another medium-voltage power conversion system, and control a power connection path between the medium-voltage power conversion system and the another medium-voltage power conversion system to supply power to the at least one load associated with the another medium-voltage power conversion system in response to an abnormal condition of the another medium-voltage power conversion system.

20. The medium-voltage power conversion system as claimed in claim 16, further comprising:
a DC circuit breaker disposed at an output side of each of the medium-voltage isolated AC-to-DC converters, wherein the control unit is configured to operate the DC circuit breaker to electrically isolate the at least one of the plurality of power modules or the at least one load from the medium-voltage power conversion system upon detecting an abnormality or for a maintenance purpose.
